(19) United States
(12) Patent Application Publication
(10) Pub. No.: US 2015/0350911 A1
(43) Pub. Date: Dec. 3, 2015

(54) System and Method for Temporarily Joining a WiFi Network

(71) Applicant: APPLE INC., CUPERTINO, CA (US)

(72) Inventors: Vinesh PALLEN, Cupertino, CA (US); Welly KASTEN, Cupertino, CA (US); Artiom SHAMIS, Cupertino, CA (US); Kapil CHHABRA, Cupertino, CA (US)

(21) Appl. No.: 14/292,524

(22) Filed: May 30, 2014

(51) Int. Cl. H04W 12/08; H04W 48/08; H04W 12/06; H04W 76/02

(52) U.S. Cl. CPC H04W 12/08; H04W 76/021; H04W 48/08; H04W 12/06

(57) ABSTRACT

A system, method and station used to establish a guest connection to a WiFi network. A first station establishes a first connection to a second station using a first communication mechanism, receives a data block from the second station, the data block including network information based upon a Basic Service Set (BSS) identification (BSSID) corresponding to a access point of a WiFi network to which the second station has connected, authentication information for connecting to the WiFi network and a time field indicating an amount of time the first station is allowed to access the WiFi network using the data block, establishes a second connection to the WiFi network using a second communication mechanism based upon the network information and authentication information of the data block and disconnects the second connection when the amount of time expires.

### BACKGROUND INFORMATION

A station may establish a connection to a communications network to perform a variety of different functionalities. The communications network may be a WiFi network that operates under standards as defined by the Institute of Electrical and Electronics Engineers (IEEE) such as 802.11a/b/g/n/ac. The station may initially associate with an access point of the WiFi network to join a Basic Service Set (BSS) of the WiFi network. Once the station joins the WiFi network, the station may use a data connectivity therewith to exchange data with other stations connected to the WiFi network, other network components, and/or other networks (e.g., Internet) to which the WiFi network is connected.

Typically with a WiFi network, authentication information is requested by the WiFi network for the station to associate therewith and join the BSS. For example, the WiFi network may require that a password be provided for the station to associate with the WiFi network. In another example, the WiFi network may require that a user identity (e.g., a login name) with a corresponding password be provided to join the BSS of the WiFi network. When a new station wishes to connect to the WiFi network, the new station must also provide this authentication information or a request to join the WiFi network may be denied. For example, a first user of a first station who knows the password for the WiFi network may notify a second user of a second station of the password.

The WiFi network may use this authentication information in a substantially static manner without a change thereto. Thus, by providing the authentication information that remains unchanged, the new station is given unlimited access to the WiFi network for an undefined amount of time. There may be instances when such unlimited access is not required or desired. Furthermore, the first user who is aware of the password may not wish to provide this information to the second user. A conventional WiFi administrator system requires that the authentication information be changed so that a subsequent attempt to join the WiFi network by the second station fails due to a previously used and now invalid password being provided. However, this requires an administrator or authorized user of the WiFi network to perform these additional steps each time the authentication information is to change.

### BRIEF DESCRIPTION OF THE DRAWINGS

FIG. 1 shows an exemplary system for temporarily joining a WiFi network.

FIG. 2 shows an exemplary station providing data for a further station to temporarily join a WiFi network.

FIG. 3 shows an exemplary data block to temporarily join a WiFi network.

FIG. 4 shows an exemplary signaling diagram for temporarily joining a WiFi network.

FIG. 5 shows an exemplary method for providing data to temporarily join a WiFi network.

FIG. 6 shows an exemplary method for temporarily joining a WiFi network.

### DETAILED DESCRIPTION

The exemplary embodiments describe a method performed by a first station that includes establishing a first connection to a second station using a first communication mechanism, receiving a data block from the second station, the data block including network information based upon a Basic Service Set (BSS) identification (BSSID) corresponding to a access point of a WiFi network to which the second station has connected, authentication information for connecting to the WiFi network and a time field indicating an amount of time the first station is allowed to access the WiFi network using the data block, establishing a second connection to the WiFi network using a second communication mechanism based upon the network information and authentication information of the data block and disconnecting the second connection when the amount of time expires.

The exemplary embodiments further describe a method performed at a first station including establishing a first connection to a WiFi network using a first communication mechanism by associating with an access point of the WiFi network with authentication information, the first station joining a Basic Service Set (BSS) having a BSS identification (BSSID) corresponding to the access point, establishing a second connection to a second station using a second communication mechanism and transmitting a data block to the second station, the data block including network information based upon the BSSID of the first station, authentication information for connecting to the WiFi network and a time field indicating an amount of time the second station is allowed to access the WiFi network using the data block, wherein the second station uses the data block to automatically join the WiFi network and disconnects from the WiFi network when the amount of time expires.

The exemplary embodiments also describe a system having first station configured to establish a first connection to a WiFi network by associating with an access point of the WiFi network using authentication information and generate a data block including network information based upon the authentication information and a time field indicating an amount of time. The system further includes a second station, wherein the first and second stations are configured to establish a second connection with each other, wherein the first station is configured to transmit the data block to the second station via the second connection and wherein the second station is configured to establish a third connection to the WiFi network based upon the network information of the data block, and to disconnect the third connection when the amount of time expires.

The exemplary embodiments may be further understood with reference to the following description and the related appended drawings, wherein like elements are provided with the same reference numerals. The exemplary embodiments are related to a system and method for a first station to provide data to a second station such that the second station may temporarily join a WiFi network. Specifically, the first station may have already joined the WiFi network and is part of a Service Set of the WiFi network. The data may further be provided from the second station to the WiFi network and include information based upon the first station for the second station to join the WiFi network without providing any authentication information by the user of the second station. The data may additionally include a timer that defines a limit upon which the second station may join the WiFi network.

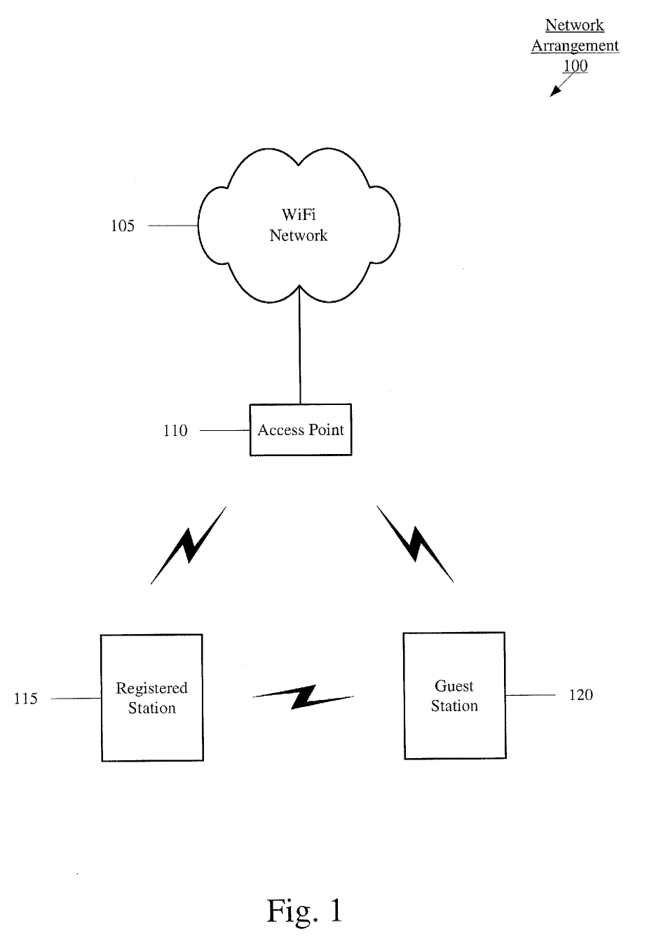

FIG. 1 shows an exemplary network arrangement 100 in which a registered station 115 provides data to a guest station 120 for temporarily joining a WiFi network 105. The registered station 115 and the guest station 120 may connect to the WiFi network 105 via an access point 110. The WiFi network 105 may use any standard of WiFi such as defined under IEEE 802.11 a/b/g/n/ac. The WiFi network 105 may also operate under any frequency range such as 2.4 GHz and 5 GHz. The WiFi network 105 may further represent any type of WiFi network such as a personal WiFi network, a home WiFi network, an enterprise WiFi network, a HotSpot, etc. In some cases, WiFi networks may be referred to as Wireless local area networks (WLANs). The WiFi network 105 may also include any network that is referred to as a WLAN.

The WiFi network 105 may have a Service Set Identification (SSID) that uniquely identifies the WiFi network 105. Thus, the SSID may be a name that is selected by an administrator or authorized user of the WiFi network 105. Therefore, the SSID may be an identifier independent of stations that are connected to the WiFi network 105. When the WiFi network 105 may be discovered using conventional discovery mechanisms, the SSID may be shown in a list of available networks for a station to connect. When the WiFi network 105 is hidden, a user (or other mechanism) may manually enter the SSID into the station so the station may discover the WiFi network.

The network arrangement 100 of FIG. 1 only shows a single access point 110. The access point 110 may represent any wireless access point for the WiFi network 105 that enables the registered station 115 and the guest station 120 to join the WiFi network 105. The WiFi network 105 may include a Basic Service Set (BSS) for the access point 110 of the WiFi network. With only a single access point 110, the WiFi network 105 may have a Basic Service Area (BSA) based upon an operating area of the access point 110 only. For example, when the WiFi network 105 is a home or personal WiFi network, there may only be a single access point 110.

Those skilled in the art will understand that the BSS may be represent the access point with all associated stations connected thereto. The specific BSS may have a unique identification (BSSID) associated therewith. Any transmission that is transmitted using the WiFi network 105 may include the BSSID such that the transmission is first properly forwarded to the access point 110. For example, the SSID may maintain transmissions to be within the WiFi network 105 despite further networks overlapping therewith. If the WiFi network 105 included further access points (not shown), the BSSID may identify the correct access point to which the transmission is to be forwarded since the transmission originated from a station included in the BSS.

Although only one access point 110 is shown in the system of FIG. 1, it should be noted that this is only exemplary and those skilled in the art will understand that the WiFi network 105 may include any number of access points. The WiFi network 105 may have an overall BSA that combines the operating areas of every access point of the WiFi network 105. Therefore, the BSA of the WiFi network 105 may be extended through further access points. For example, the WiFi network 105 may be an enterprise WiFi network or a HotSpot that include multiple access points to create a relatively large BSA compared to a home or personal WiFi network.

In a substantially similar manner discussed above for the access point 110, each additional access point may have a corresponding BSS and BSSID. The combination of all the BSS of the WiFi network 105 may be an Extended Service Set (ESS) that may be identified with an identification (ESSID). Those skilled in the art will understand that the ESSID may be substantially similar in concept to the SSID. However, the ESSID may utilize a different identification format that is not based upon an arbitrary selection of an administrator or authorized user. The ESSID may also be further defined as a plurality of BSS that share a common SSID.

The registered station 115 and the guest station 120 may connect to the WiFi network 105 by associating with the access point 110. The registered station 115 may be any device that has joined the WiFi network using conventional means such as associating with the access point 110 by providing authentication information (e.g., a network password). The registered station 115 may accordingly be a device that has joined a BSS of the access point 110 and optionally an ESS of the WiFi network 105 based upon the configuration of the WiFi network 105.

The guest station 120 may also associate with the access point 110. According to the exemplary embodiments, the guest station 120 may receive a data block from the registered station 115 and use this data block to join the WiFi network 105. For illustrative purposes, the data block will be described herein as a Binary Large Object (BLOB). Therefore, the registered station 115 may be a device that has authentication information for the WiFi network 105 while the guest station 120 may be a device that does not have this authentication information.

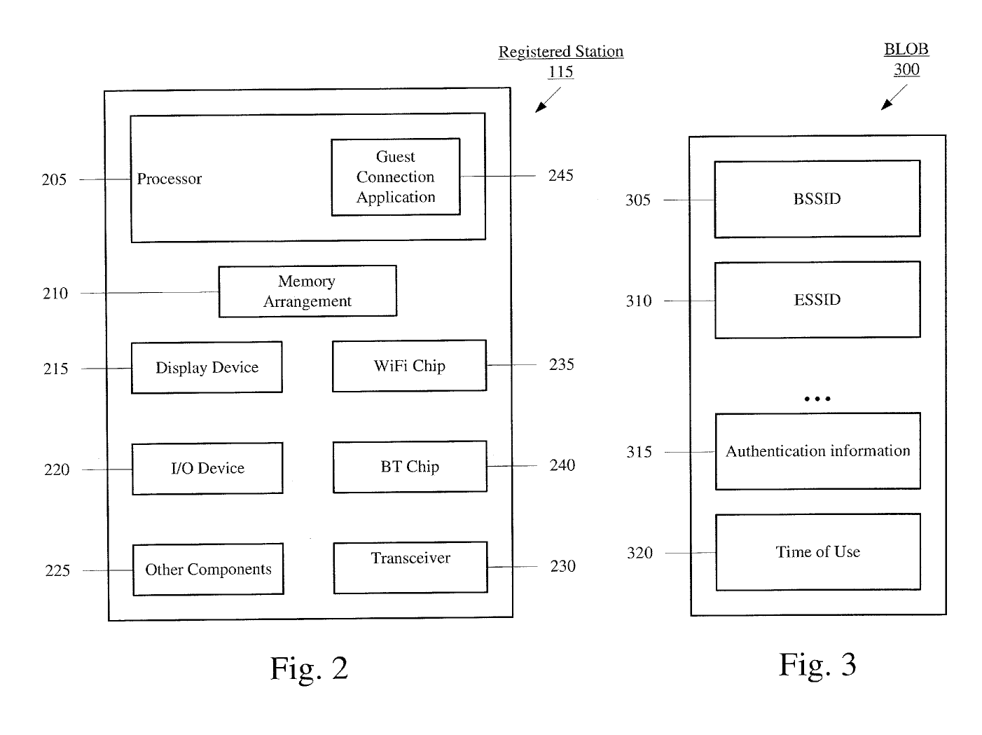

The registered station 115 may include a variety of components. FIG. 2 shows components of the registered station 115 that provides data to the guest station 120 to temporarily join the WiFi network 105. The registered station 115 may represent any electronic device configured to join the WiFi network 105, in particular, join the BSS and/or ESS of the WiFi network 105. Furthermore, the registered station 115 may be configured to generate the BLOB for the guest station 120. The registered station 115 may be a portable device (e.g., a cellular phone, a smartphone, a tablet, a phablet, a laptop, etc.) or a stationary device (e.g., desktop terminal). The registered station 115 may include a processor 205, a memory arrangement 210, a display device 215, an input/output (I/O) device 220, other components 230, and a transceiver 230.

The processor 205 may be configured to execute a plurality of applications of the registered station 115. For example, the applications may include a web browser when connected to the WiFi network 105. In another example, the applications may include an association application that establishes a connection between the WiFi network 105 and the registered station 115. In a further example and according to the exemplary embodiments, the applications may include a guest connection application 245. The guest connection application 245 may generate the BLOB to be provided to the guest station 120. The guest connection application 245 and the BLOB will be described in further detail below.

It should be noted that the above noted applications each being an application (e.g., a program) executed by the processor 205 is only exemplary. The functionality associated with the applications may also be represented as a separate incorporated component of the registered station 115 or may be a modular component coupled to the registered station 115, e.g., an integrated circuit with or without firmware.

The memory arrangement 210 may be a hardware component configured to store data related to operations performed by the registered station 115. For example, the memory arrangement 210 may store the BSSI and/or the ESSID upon connecting to the WiFi network 105 by associating with the access point 110. The memory arrangement 210 may also store a contact list for a user of the registered station 115. As will be described in further detail below, the contact list may provide an authorization mechanism for the guest connection application 245 to provide the BLOB.

The display device 215 may be a hardware component configured to show data to a user while I/O device 220 may be a hardware component configured to receive inputs from the user and output corresponding data such as a hostname request. As will be described in further detail below, the guest connection application 245 may provide a user interface (UI) to the user of the registered station 115 relating to providing the BLOB to the guest station 120. The user may utilize the I/O device 220 to enter any requested fields regarding the BLOB. The other components 225 may include a portable power supply (e.g., battery), a data acquisition device, ports to electrically connect the registered station 115 to other electronic devices, an audio I/O device, etc.

The transceiver 230 may enable the registered station 115 to communicate with the WiFi network 105 as well as with the guest station 120. As illustrated in FIG. 2, the registered station 115 may also include a WiFi chip 235 and a BlueTooth (BT) chip 240. The WiFi chip 235 and the BT chip 240 may interact with transceiver 225 for the respective functionalities to be performed, e.g., the transmitting and receiving of signals in the corresponding frequency ranges for WiFi and Bluetooth functionality. The registered station 115 may also include an antenna or antenna arrangement that propagates signals generated by the WiFi chip 235 and the BT chip 240.

The WiFi chip 235 may be configured to enable the registered station 115 to operate using a band or frequency of the WiFi network 105. Therefore, the WiFi chip 235 may provide a relatively long-range wireless communication mechanism for transmissions to be received and transmitted from the registered station 115. The BT chip 240 may also be configured to enable the registered station 115 to operate using a band or frequency corresponding to BT technology. Therefore, the BT chip 240 may provide a relatively short-range wireless communication mechanism for transmissions to be received and transmitted from the registered station 115. It should be noted that the use of BT is only exemplary. For example, the BT technology may represent any short-range communication mechanism between the registered station 115 and the guest station 120 such as Infrared (IR) communication. It should also be noted that the use of a wireless short-range communication is only exemplary. For example, the short-range communication mechanism may utilize a wired connection using ports of the registered station 115 and the guest station 120 and a further connector.

Returning to the network arrangement 100 of FIG. 1, the guest station 120 may be any electronic device that is substantially similar to the registered station 115. Specifically, the guest station 120 may have a corresponding processor 205, a memory arrangement 210, a display device 215, an I/O device 220, other components 225, and a transceiver 230 that includes both a corresponding WiFi chip 235 and a BT chip 240. Therefore, if the authentication information of the WiFi network 105 known by the user of the registered station 115 is also known by the user of the guest station 120, the guest station 120 may use conventional association means to join the WiFi network 105 via the access point 110. However, according to the exemplary embodiments, the user of the guest station 120 is not required to have the authentication information to join the WiFi network 105. Thus, in contrast to the registered station 115, the guest station 120 may optionally include the guest connection application 245. That is, the exemplary embodiments do not require the guest station 120 to include any additional software/hardware requirements to implement the manner of temporarily joining the WiFi network 105.

As discussed above, the guest connection application 245 of the registered station 115 may generate the BLOB to be provided to the guest station 120. FIG. 3 shows an exemplary BLOB 300 to enable the guest station 120 to temporarily join the WiFi network 105. Specifically, the BLOB 300 includes a plurality of fields with associated information. As illustrated, the BLOB 300 may include a BSSID field 305, an ESSID field 310, an authentication field 315 and a time field 320. The BLOB 300 may however include further fields. Initially, the BLOB may represent any data block that utilizes binary formatted data. However, it should be noted that the use of a BLOB is only exemplary. The BLOB 300 may represent any data packet, data block, etc. that includes the fields and/or information described herein. The BLOB 300 may be encrypted at the link layer. Specifically, as will be described in greater detail below, the registered station 115 and the guest station 120 may set up a peer-to-peer link to communicate the BLOB 300. Thus, the BLOB 300 may be communicated as being encrypted at the link layer that does not allow a user of the guest station 120 to view the contents of the BLOB 300.

The BSSID field 305 may include the unique identifier associated with the BSS including the access point 110, the registered station 115, and any other stations (not shown) that are associated with the access point 110. Thus, the guest connection application 245 of the registered station 115 may include the BSSID known to the registered station 115 upon joining the WiFi network 105. The ESSID field 310 may include the unique identifier associated with the ESS including the BSS relative to the access point 110 and any other BSS of the WiFi network (not shown). Thus, the guest connection application 245 of the registered station 115 may include the ESSID known to the registered station 115 upon joining the WiFi network 105. The authentication information 315 may include any of the authentication information (e.g., user ID, password, etc.) that the registered station 115 is providing to the guest station 120 in order for the guest station to associate with the access point 110. Those skilled in the art will understand that the BSSID, the ESSID and the authentication information may provide the necessary information for a station to identify and join the WiFi network 105 via the access point 110. Thus, this information may be used as a basis for connecting to the WiFi network 105.

The time field 320 may be an amount of time defined by a user of the registered station 115 or by the guest connection application 245 of the registered station in which the BLOB 300 may be used by the guest station 120 to join the WiFi network 105. In this manner, the guest station 120 may only be allowed to temporarily join the WiFi network 105. For example, as discussed above, the guest connection application 245 may present a UI to a user of the registered station 115 via the display device 215 that requests a time input to be entered via the I/O device 220 for the time field 320. In another example, the guest connection application 245 may automatically select a predetermined time input for the time field 320. In yet another example, the guest connection application 245 may determine an identity of the guest station 120 and reference a database that includes a predetermined indication of the time input for the time field 320. The time field 320 may indicate any amount of time such as a period of minutes, a period of hours, a period of days, etc.

The BLOB 300 may be generated based upon a variety of factors. In a first example, the BLOB 300 may be generated based upon a minimalist standard. For example, the BLOB 300 may include only the service set information including the BSSID field 305 and optionally the ESSID field 310 as well as the authentication information field 315 and the time field 320. When the WiFi network 105 includes multiple access points 110, the BLOB 300 may include the BSSID field 305, the ESSID field 310, the authentication information field 315 and the time field 320. However, if the WiFi network 105 includes only a single access point 110, the BLOB 300 may include only the BSSID field 305 and the time field 320. In a second example, the BLOB 300 may be generated based upon a configuration of the guest connection application 245. For example, the guest connection application 245 may require that identities of the registered station 115 and the guest station 120 are also to be included. Thus, the BLOB 300 may include further fields that indicate these identities. The BLOB 300 may additionally include fields that indicate identities of users associated with the identities of the stations.

According to the exemplary embodiments, the registered station 115 may connect to the WiFi network 105 via the access point 110. Specifically, an association process may be performed by the association application of the registered station 115 in which authentication information is provided manually (e.g., if joining the WiFi network 105 for a first time or when the authentication information is not stored in the memory arrangement 210) or automatically (e.g., if the authentication information is stored in the memory arrangement 210 from a previous input by the user or from a previous connection to the WiFi network 105). Accordingly, the registered station 115 may join a corresponding BSSID relative to the access point 110 and a corresponding ESSID of the WiFi network 105 (if applicable).

At a subsequent time, the guest station 120 may desire to join the WiFi network 105. However, as described above, the guest station 120 and/or the user of the guest station 120 may not have the authentication information and the user of the registered station 115 may not want to provide the authentication information to the user of the guest station 120. According to the exemplary embodiments, the guest station 120 may request the registered station 115 to assist in granting access to the WiFi network 105 without requiring the user of the guest station 120 to receive the authentication information. Rather, the registered station 115 may exchange the BLOB 300 with the guest station 120. In one example, a short-range exchange of transmissions (e.g., using the BT chip 240 of the registered station 115 and a corresponding BT chip of the guest station 120) may be used to transmit the BLOB 300 to the guest station 120.

The use of the short-range communication to provide the BLOB 300 may also provide a security mechanism such that the BLOB 300 may be transmitted from the registered station 115 to the guest station 120 only when within a limited proximity range. That is, the guest connection application 245 may be configured to utilize only the short-range communication, such as the BT chip 240, to transmit the BLOB 300. Thus, the guest station 120 may only receive the BLOB 300 when the guest station 120 is within the operating range of the BT chip 240 of the registered station 115. Furthermore, the time field 320 may be required such that the guest station 120 is only allowed to join the WiFi network 105 temporarily. The time field 320 may also provide a further security mechanism in that it may be required that the time field 320 entry is performed manually. For example, for each occurrence of generating and providing the BLOB 300, the user of the registered station 115 may be required to enter a time input for the time field 320. In this way, accidental sharing of the WiFi network 105 or providing the BLOB 300 accidentally may be prevented.

The exemplary embodiments incorporate a first portion and a second portion of an overall process to enable the guest station 120 to temporarily join the WiFi network 105. The first portion incorporates the various features described above in which a short-range communication mechanism is used. Specifically, a peer-to-peer (P2P) connection may be established between the registered station 115 and the guest station 120 using the BT chip 240 to request access to the WiFi network (from the guest station 120 to the registered station 115) and to provide the BLOB 300 (from the registered station 115 to the guest station 120). Upon establishing this connection, the exemplary embodiments provide a pull model or a push model for the BLOB 300 to be transmitted.

The pull model may relate to the guest station 120 transmitting a request to the registered station 120 for the BLOB 300. More generally, the request may be to access the WiFi network 105. In a first example, the guest station 120 may execute its own guest connection application 245 that transmits the request over the short range P2P connection (e.g., BT connection). The guest connection application 245 of the registered station 115 may receive the request and generate the BLOB 300. The user or the guest connection application 245 of the guest station 120 may provide various inputs to be included in the request such that the guest connection application 245 of the registered station 115 may determine an authorization to provide the BLOB 300. As discussed above, the contact list of the registered station 115 may indicate authorized users/devices that may be provided the BLOB 300. Thus, the request may include an identity of the user or the guest station 120. In a second example, the guest station 120 may open an application such as a browser and enter an input that is supported by the registered station 115, specifically the guest connection application 245. The guest station 120 may provide various inputs to transmit a request via the browser application. In this manner, the guest station 120 may not require any further software or applications to connect to the WiFi network.

The push model may relate to the registered station 115 transmitting the BLOB 300 to the guest station 120. For example, the guest connection application 245 of the registered station 115 may perform an automatic procedure upon detecting the guest station 120 within proximity of the registered station 115 (e.g., within an operating range of the BT chip 240). The guest station 120 may be configured to enable the BLOB 300 to be received and used. Thus, the registered station 115 may determine the presence of the guest station 120, verify the guest station 120 is authorized to receive the BLOB 300 (e.g., via the contact list of the registered station 115) and transmit the BLOB 300 to the guest station 120. It should be noted that the exemplary embodiments may utilize the pull model alone, the push model alone, or a combination thereof. However, for illustrative purposes, the description herein refers to the Pull model.

The second portion of the overall process incorporates the use of the BLOB 300 by the guest station 120 to join the WiFi network 105 automatically using the BSSID field 305 and/or ESSID field 310 and the authentication information field 315 included in the BLOB 300 as well as to use the WiFi network 105 for a limited time as indicated by the time field 320. The BLOB 300 may be associated with instructions for use by the guest station 120. For example, the guest station 120 may discover the WiFi network 105 and utilize the BSSID, the ESSID and authentication information as indicated in the respective fields to join the WiFi network 105. As discussed above, this information may provide a minimum requirement for the guest station 120 to join the WiFi network 105. Thus, the guest station 120 may join the WiFi network 105 as if it were the registered station 115 using the BSSID, ESSID and authentication information included in the BLOB 300 that was transmitted by the registered station 115.

During the life of the BLOB 300, the guest station 120 may continue to utilize the WiFi network 105. For example, the guest station 120 may continually stay connected to the WiFi network 105 using the BLOB 300 during the time set forth in the time field 320. In another example, the guest station 120 may disconnect from the WiFi network 105 but re-establish a connection to the WiFi network 105 using the BLOB 300 so long as it is still within the time set forth in the time field 320. Specifically, the BLOB 300 may be stored in a memory arrangement of the guest station 120 for subsequent use. However, upon the BLOB 300 expiring (i.e., the time set in the time field 320 lapsing), the BLOB 300 may be permanently deleted from the guest station 120. Once the BLOB 300 is deleted, the guest station 120 may no longer be capable of identifying the WiFi network 120 and/or provide the necessary information to establish a connection to the WiFi network 105 (e.g., does not have BSSID and ESSID information). In a first example, the BLOB 300 may include instructions for the deletion of the BLOB 300 (as well as any propagated information) from the guest station 120. In this manner, the guest station 120 may not retain information included in the BLOB 300. In a second example, the BLOB 300 may include a feature to detect when a local or global time of the guest station 120 is being changed. That is, a user of the guest station 120 may “rewind” the clock to artificially extend an access time to use the WiFi network 105. The BLOB 300 may include a security mechanism to track a real time of use of the BLOB 300 to prevent a dependency on a local clock of the guest station 120 to determine whether the access time indicated in the time field 320 has lapsed.

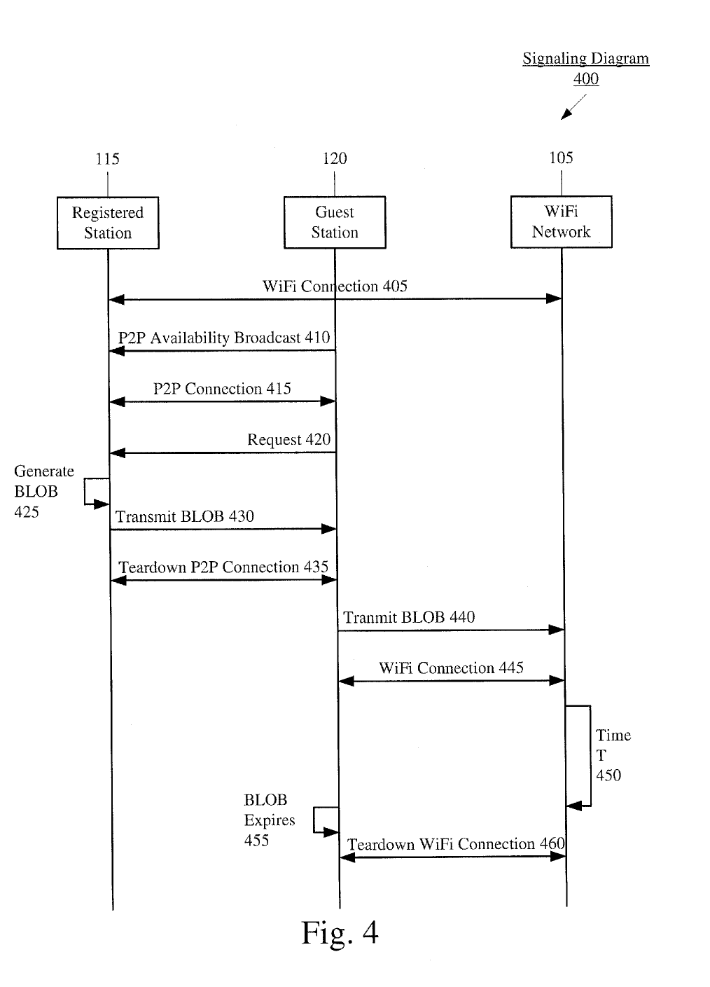

FIG. 4 shows an exemplary signaling diagram 400 for the guest station 120 to temporarily join the WiFi network 105 by being provided the BLOB 300 from the registered station 115. The signaling diagram 400 relates to an overall process as related to the registered station 115, the guest station 120, and the WiFi network 105. As indicated above, the signaling diagram 400 also relates to utilizing a short-range communication such as BT and further relates to a pull mechanism.

Initially, a WiFi connection 405 may be established between the registered station 115 and the WiFi network 105. Specifically, the registered station 115 may provide authentication information for an association process to be performed between the registered station 115 and the access point 110. The registered station 115 may join the BSS of the access point 110 and the ESS of the WiFi network 105.

Subsequently, the guest station 120 may wish to join the WiFi network 105. The exemplary embodiments may be utilized for the guest station 120 to join the WiFi network 105 without the user of the registered station 115 providing authentication information directly to a user of the guest station 120. Accordingly, the above-described first portion of the overall process may be performed to provide the BLOB 300 from the registered station 115 to the guest station 120. Specifically, with regard to using BT as the short-range communication means, the guest station 120 may broadcast a P2P availability 410 over BT using a respective BT chip. For example, the broadcast may relate to the guest station 120 being discoverable over a BT frequency. The registered station 115 may discover the guest station 120 and establish a short range P2P connection 415 therewith. As a pull model is used, the guest station 120 may then transmit a request 420 to the registered station 115. The request 420 may be general in that the request is to join the WiFi network 105 or may be specific in that the request is for a BLOB 300.

Upon receiving the request, the registered station 115 may initially perform a variety of authorizing processes (not shown). For example, the above described feature may be used in which an identity included in the request is referenced to a stored contact list of the registered station 115. If a match is found, the guest connection application 245 may determine that the request is valid. However, if no match is found, the guest connection application 245 may deny the request. In another example, the request may be received by the guest connection application 245 of the registered station 115, which displays a prompt to the user. The prompt may include a general acceptance for the request or may include specific details such as an identity of the requestor. The user may manually accept or deny the request.

When the request for access to the WiFi network 105 is accepted, the guest connection application 245 may generate 425 the BLOB 300. As discussed above, the BLOB 300 may include the BSSID information, the ESSID information and the authentication information of the registered station 115 to be included in the BSSID field 305, the ESSID field 310 and the authentication information field 315, respectively. Furthermore, as discussed above, if the access to the WiFi network 105 by the guest station 120 is to be limited in time, the BLOB 300 may include the time field 320 which may be defined automatically by the guest connection application 245 of the registered station 115 or manually by a user of the registered station 115 using a prompt to enter a time input. Once the BLOB 300 is generated, it may be transmitted 430 from the registered station 115 to the guest station 120 over the short range P2P connection. After the BLOB 300 is transmitted, a teardown procedure 435 may be performed for the short range P2P connection. At this stage, the registered station 115 may have completed any steps in the overall process.

Once the guest station 120 has received the BLOB 300, the guest station 120 may transmit 440 the BLOB 300, which provides information, namely the BSSID information, the ESSID information, and the authentication information to automatically join the WiFi network 105 and establish the WiFi connection 445. The guest station 120 may utilize the WiFi network 105 for the duration indicated in the time field 320. As illustrated, the time field 320 may include a time T 450 during the which the WiFi connection may be used. Thus, after a time T has lapsed, the BLOB 300 expires 455. If the guest station 120 is still connected to the WiFi network 105, a teardown procedure 460 may be performed for the WiFi connection between the guest station 120 and the WiFi network 105. If the guest station 120 is no longer connected to the WiFi network 105, a subsequent connection to the WiFi network 105 by the guest station 120 may be prevented, as the necessary information is not available. For example, the BLOB 300 expiring may result in the permanent deletion of the BLOB 300 from the guest station 120.

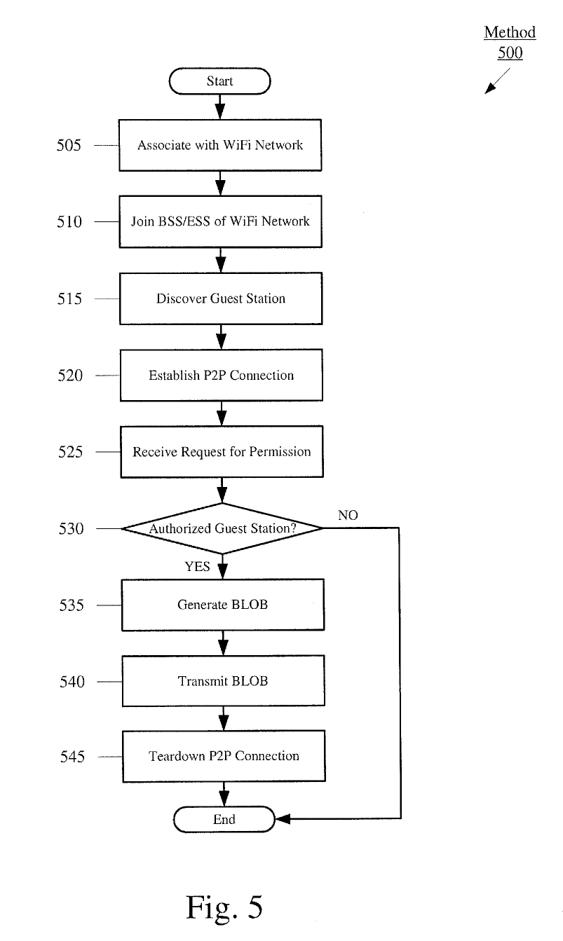

FIG. 5 shows an exemplary method 500 for providing data to temporarily join a WiFi network. The method 500 is described with regard to the registered station 115. Accordingly, the method 500 relates to the first portion of the overall process of the exemplary embodiments, e.g., signals 405-435 of signaling diagram 400. The method 500 will be described in further detail with regard to corresponding aspects of the signaling diagram 400 of FIG. 4. The method 500 will be described with regard to the network arrangement 100 of FIG. 1, the components of the registered station 115 of FIG. 2, and the BLOB 300 of FIG. 3.

In step 505, the registered station 115 may associate with the WiFi network 105. Specifically, the registered station 115 may discover the WiFi network 105 (e.g., selection of the SSID) and may provide authentication information (e.g., network password) to authorize the connection to the WiFi network 105. Thus, in step 510, the registered station 115 may join a BSS of the access point 110 and a ESS of the WiFi network 105. While connected to the WiFi network 105, the registered station 115 may utilize a data connectivity to exchange transmissions with other stations connected to the WiFi network 105 (e.g., stations in the BSS or ESS), network components, other networks (e.g., Internet), etc.

In step 515, the registered station 115 may discover the guest station 120 using the BT chip 240 or any short-range communication means. As discussed above, the guest station 120 may wish to join the WiFi network 105 at a time subsequent to the registered station 115 joining the WiFi network 105. Using BT technology, the guest station 120 may have broadcast an availability for the guest station 120 to be discovered using a BT frequency (e.g., using a BT chip of the guest station 120). The registered station 115 may discover the guest station 120 in this manner. In view of the short range of the BT chip 240, the guest station 120 may be within a local proximity of the registered station 115. In step 520, the registered station 115 may establish a short range P2P connection with the guest station 120. In step 525, the registered station 115 may receive a request for the guest station to join the WiFi network 105 over the short range P2P connection. Specifically, the request is received by the guest connection application 245 of the registered station 115.

In step 530, the guest connection application 245 determines whether the guest station 120 is authorized to join the WiFi network 105. This determination may be performed in a variety of manners. In a first example, an automatic determination may be made based upon whether an identity included in the request associated with the guest station 120 corresponds to an entry in a contact list of the registered station 115. In a second example, a manual determination may be made based upon whether a user of the registered station 115 provides an input indicating an authorization. If the request from the guest station 120 is denied, the guest connection application 245 ends the method 500.

If the guest station 120 is authorized to join the WiFi network 105, the guest connection application 245 continues the method 500 to step 535. In step 535, the guest connection application 245 generates the BLOB 300. As discussed above, the BLOB 300 may be generated in a variety of manners. However, the BLOB 300 may minimally include the BSSID field 305 and/or the ESSID field 310 and the authentication information field 315. The BLOB 300 may also include the time field 320 that indicates an allowed access time for the guest station 120 to use the WiFi network 105. Specifically, the time field 320 may be provided manually by requesting the user of the registered station 115 to provide a time input or automatically based upon predetermined time parameters. In step 540, the registered station 115 transmits the BLOB 300 to the guest station 120 using the short range P2P connection. In step 545, the short range P2P connection is terminated (i.e., a teardown procedure is performed). Subsequently, the guest connection application 245 ends the method 500. Thus, the participation regarding the registered station 115 may end upon completion of the first portion of the overall process.

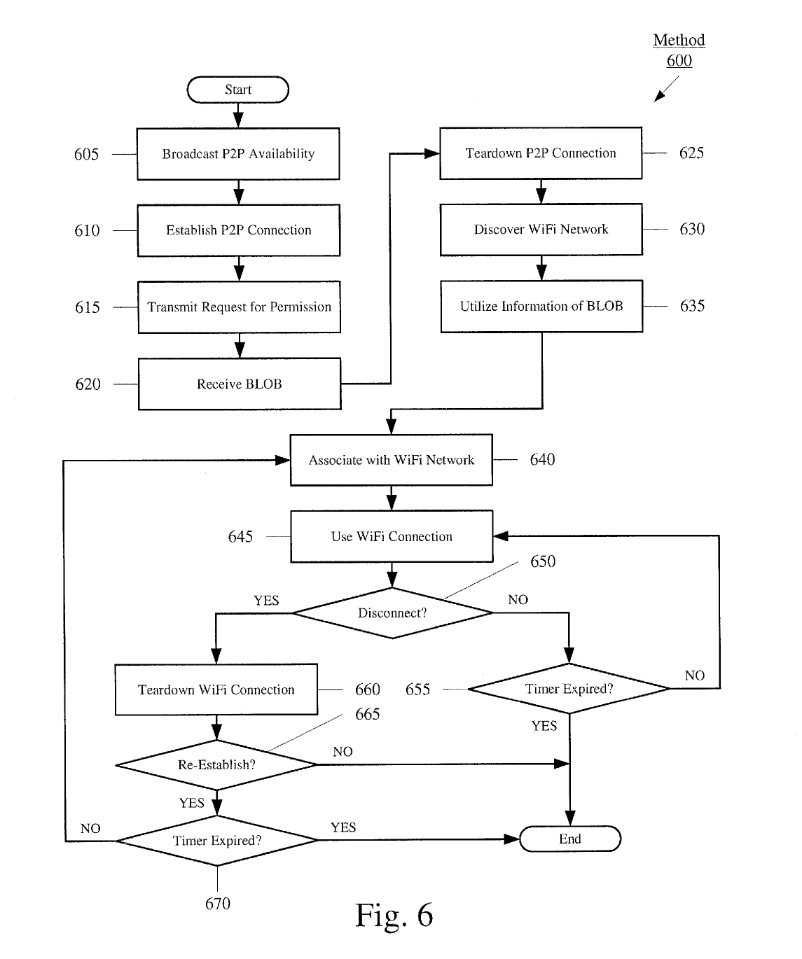

FIG. 6 shows an exemplary method 600 for temporarily joining a WiFi network. The method 600 is described with regard to the guest station 120. Accordingly, the method 600 relates to the first and second portions of the overall process of the exemplary embodiments. The method 600 will be described in further detail with regard to corresponding aspects of the signaling diagram 400 of FIG. 4. The method 600 will be described with regard to the network arrangement 100 of FIG. 1, the components of the registered station 115 of FIG. 2, and the BLOB 300 of FIG. 3.

In step 605, the guest station 120 broadcasts an availability for a short range P2P connection. As discussed above, this may relate to using BT technology in which the BT chip of the guest station 120 interacts with the BT chip 240 of the registered station 115. Upon broadcasting the availability indication, the registered station 115 may respond. Thus, in step 610, the guest station 120 may establish the short range P2P connection with the registered station 115. In step 615, the guest station 120 transmits a request for permission to join the WiFi network 105. As discussed above, the request may be transmitted when the exemplary embodiments utilize a pull model. The request may include a variety of information such as an identity of the guest station 120, an identity of the user of the guest station 120, other identification information associated with the guest station 120 and/or its user, requested access time, etc. The request may be generated using a variety of manners. For example, the guest station 120 may include a respective guest connection application 245 that generates the request with all required information included therein.

In step 620, the guest station 120 receives the BLOB 300 that is generated by the registered station 115 in response to the request. As discussed above, the registered station 115 may only provide the BLOB 300 if authorizing procedures are properly passed. Thus, it may be assumed for purposes of the method 600 that the guest station 120 is authorized to join the WiFi station 105. The BLOB may include the BSSID field 305, the ESSID field 310, the authentication information field 315 and the time field 320. Again, the BSSID field 305 and the ESSID field 310 may be based upon the BSSID and ESSID information of the registered station 115. The time field 320 may be provided but may also be based upon a requested access time as indicated in the request. After receiving the BLOB 300, in step 625, the short range P2P connection is terminated.

Beginning in step 630, the second portion of the overall process may be performed. In step 630, the guest station 120 discovers the WiFi network 630. For example, the BSSID and ESSID information in the BSSID field 305 and the ESSID field 310, respectively, may be used initially to identify the WiFi network 105. In step 635, the guest station 120 may use the BSSID, ESSID and authentication information of the BLOB 300. Thus, in step 640, the guest station 120 may associate with the access point 110 and join the WiFi network 105. Accordingly, in step 645, the guest station 120 may use the WiFi data connectivity with the WiFi network 105.

At a time subsequent to joining the WiFi network 105, in step 650, the guest station 120 may determine whether the WiFi connection is to be terminated. For example, the guest station 120 may no longer be within an operating area of the access point 110 in which access to the WiFi network 105 may no longer be capable due to the limitations of the access point 110 and/or the WiFi chip of the guest station 120. In another example, the guest station 120 may no longer require the WiFi data connectivity and may terminate the connection prior to any time limit that may be imposed.

If the guest station 120 is to maintain the WiFi connection, the guest station 120 continues the method 600 to step 655. In step 655, the guest station 120 determines whether the access time as indicated in the time field 320 has expired. More specifically, the guest station 120 determines whether the information of the BLOB 300 is still available since the BLOB 300 is configured to be permanently deleted and no longer available upon the access time expiring. If the BLOB 300 is still available for use, the guest station 120 returns the method 600 to step 645 to continue utilizing the WiFi data connectivity. However, if the BLOB 300 is no longer available, the guest station 120 ends the method 600.

Returning to step 650, if the guest station 120 is to disconnect from the WiFi network 105, the guest station 120 continues the method 600 to step 660. In step 660, the guest station 120 performs a teardown procedure for the connection to the WiFi network 105, specifically with the access point 110. At this point, the guest station 120 is no longer connected to the WiFi network 105 (via the WiFi data connectivity) nor the registered station 115 (via the short range P2P connection). However, the BLOB 300 may still be stored in a memory arrangement of the guest station 120.

At a subsequent time, in step 665, the guest station 120 determines whether the WiFi data connectivity to the WiFi network 105 is to be re-established. If the WiFi network 105 is no longer to be used, the guest station 105 ends the method 600. However, if the connection to the WiFi network 105 is again required, the guest station 120 continues the method 600 to step 670. Due to the time limitations of the BLOB 300, in step 670, the guest station 120 determines whether the access time as indicated in the time field 320 has expired. Again, this may relate to whether the information of the BLOB 300 is still available since the BLOB 300 is configured to be permanently deleted and no longer available upon the access time expiring. If the BLOB 300 is still available for use, the guest station 120 returns the method 600 to step 640 to associate with the WiFi network 640 utilizing the information included in the BLOB 300. However, if the BLOB 300 is no longer available, the guest station 120 ends the method 600.

It should be noted that the exemplary embodiments described above may include a variety of modifications to address a variety of different configurations. In a first example, the authorizing feature utilizing the contact list may be a toggled. Specifically, a user of the registered station 115 may enable or disable the contact list authorizing feature. Thus, if disabled, the guest connection application 245 may provide a prompt for the user to enter an authorizing indication for each request. If disabled, the guest connection application 245 may be configured to automatically enable all requests. However, a follow-up prompt to request an access time for the request may be used as a further security measure for inadvertent access to the WiFi network 105 to be prevented.

In a second example, the above noted security mechanism to prevent artificial extensions based upon a change in a local clock may be used. For example, the BLOB 300 may include an internal timer feature that tracks a time from when the BLOB 300 is received by the guest station 120, tracks a time from when the BLOB 300 is first used by the guest station 120, or calculates an expiry time based upon a clock time and an access time. The internal timer feature may prevent the artificial extension simply from using the time indicated in the internal timer feature. The BLOB 300 may also provide a UI for the user of the guest station 120 upon when the BLOB 300 is to expire. If this UI indicates a countdown or a local time when the BLOB 300 expires, the internal timer feature may adjust the expiry time accordingly if a change in time zone, a change due to daylight savings, a manual change in time, etc. is performed.

In a third example, the BLOB 300 may be adjusted depending on the WiFi network 105. For example, there may be some WiFi networks in which credentials are device specific such as in an enterprise WiFi network, an ad hoc WiFi network, etc. The BLOB 300 may be modified to accommodate these networks that use a device specific authentication procedure. That is, the BLOB 300 may include network information based upon the BSSID and ESSID information of the registered device and include such information in the BSSID field 305 and the ESSID field 310 of the BLOB 300. In a particular embodiment, the access point 110 of the WiFi network 105 that only accepts device specific information may be modified as well to accept information included in the BLOB 300 from the guest station 120.

In a fourth example and as discussed above, the BLOB 300 may include any number of fields. However, in one particular embodiment, the BLOB 300 may include a minimal amount of fields such as only the BSSID field 305, the ESSID field 310, and the time field 320. By encapsulating only the absolute necessary network information and credentials in the BLOB 300, the efficiency at which the guest station 120 may join the WiFi network 105 may be maximized.

The exemplary embodiments provide a system and method for a first station to provide a data block to a second station. The first station may join a WiFi network using authentication information and have BSSID and ESSID information therewith. The data block may include the BSSID, ESSID and authentication information of the first station such that the data block may be used by the second station to join the WiFi network. The data block may have an associated time field that indicates an access time in which the second station may utilize the WiFi network.

The above exemplary embodiments may be used for a variety of reasons in a variety of environments. In an exemplary use case, a guest may be present at a user's house that has a home WiFi network. The guest may have a guest device and is interested in using the home WiFi network for a few hours or a couple of days. Without using the exemplary embodiments, the user is required to tell the guest the network name (i.e., SSID) and the authentication information (e.g., password) in clear text or even enter the authentication information by the user on the guest device. However, with the exemplary embodiments, using a Push model, the user may use a user device already connected to the home WiFi network and simply push the network access to the guest device in proximity using the short range P2P connection or using a Pull model, the guest device may request the access and the user device may accept or reject the request for network access. Thus, no exchange of network identity or authentication information is required between the user device and the guest device.

The above-described exemplary embodiments may also extend beyond the above example at a home WiFi network. That is, the exemplary embodiments may be applied to more commercial scenarios. For example, the BLOB to enable a guest station to temporarily join the WiFi network may be used at an airport providing an airport-wide HotSpot, a hotel providing wireless Internet access, a café providing a restaurant-wide HotSpot, etc. This may replace a need for a captive network and/or a need for authentication information to always be provided and subsequently replaced. For example, a receptionist or a front desk personnel at a hotel may have an enterprise station that is connected to the enterprise WiFi network using authentication information. The enterprise station may share the network access to a guest station for the duration of a stay during a check-in. Furthermore, the exemplary embodiments provide a flexible manner for more parameters to be included and expose an Application Programming Interface (API) for control thereof, thereby enabling third parties or other parties to build network sharing applications.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Mac platform and MAC OS, etc. In a further example, the exemplary embodiments of the above described method may be embodied as a program containing lines of code stored on a non-transitory computer readable storage medium that, when compiled, may be executed on a processor or microprocessor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

What is claimed is:

1. A method, comprising:
at a first station:
establishing a first connection to a second station using a first communication mechanism;
receiving a data block from the second station, the data block including network information based upon a Basic Service Set (BSS) identification (BSSID) corresponding to a access point of a WiFi network to which the second station has connected, authentication information for connecting to the WiFi network and a time field indicating an amount of time the first station is allowed to access the WiFi network using the data block;
establishing a second connection to the WiFi network using a second communication mechanism based upon the network information and authentication information of the data block; and
disconnecting the second connection when the amount of time expires.

2. The method of claim 1, wherein the WiFi network includes at least one further access point, the network information of the data block being further based upon an Extended Service Set Identifier (ESSID) of the second station.

3. The method of claim 1, further comprising:
transmitting a request to the second station for access to the WiFi network.

4. The method of claim 1, wherein the data block is received upon establishing the first connection.

5. The method of claim 1, wherein the first station is in a local proximity to the second station and wherein the first communication mechanism is BlueTooth and the first connection is a BlueTooth connection.

6. The method of claim 5, further comprising:
transmitting an availability indication for the BlueTooth connection to be established as a short-range peer-to-peer (P2P) connection.

7. The method of claim 1, wherein the data block is encrypted at a link layer of the first connection.

8. The method of claim 1, wherein the second communication mechanism is a WiFi data connectivity.

9. The method of claim 1, further comprising:
permanently deleting the data block when the amount of time expires.

10. The method of claim 1, further comprising:
determining whether the second connection has been disconnected;
determining that the second connection is to be re-established;
determining whether the amount of time is expired; and
re-establishing the second connection if the amount of time is not expired.

11. A method comprising:
at a first station:
establishing a first connection to a WiFi network using a first communication mechanism by associating with an access point of the WiFi network with authentication information, the first station joining a Basic Service Set (BSS) having a BSS identification (BSSID) corresponding to the access point;
establishing a second connection to a second station using a second communication mechanism; and
transmitting a data block to the second station, the data block including network information based upon the BSSID of the first station, authentication information for connecting to the WiFi network and a time field indicating an amount of time the second station is allowed to access the WiFi network using the data block, wherein the second station uses the data block to automatically join the WiFi network and disconnects from the WiFi network when the amount of time expires.

12. The method of claim 11, further comprising:
requesting a time input for the time field from a user of the first station.

13. The method of claim 11, wherein the WiFi network includes at least one further access point, the first station joining an Extended Service Set (ESS) having an ESS identification (ESSID) corresponding to the WiFi network, the network information of the data block being further based upon the ESSID of the first station.

14. The method of claim 11, further comprising:
receiving a request from the second station for access to the WiFi network.

15. The method of claim 11, wherein the data block is transmitted upon establishing the second connection.

16. The method of claim 11, wherein the first communication mechanism is a WiFi data connectivity.

17. The method of claim 11, wherein the first station is in a local proximity to the second station and wherein the second communication mechanism is BlueTooth and the second connection is a BlueTooth connection.

18. The method of claim 17, further comprising:
receiving an availability indication from the second station for the BlueTooth connection to be established as a short-range peer-to-peer (P2P) connection.

19. The method of claim 11, further comprising:
determining an identity of the second station;
determining whether the identity is authorized for access to the WiFi network.

20. A system, comprising:
a first station configured to:
establish a first connection to a WiFi network by associating with an access point of the WiFi network using authentication information;
generate a data block including network information based upon the authentication information and a time field indicating an amount of time; and
a second station;
wherein the first and second stations are configured to establish a second connection with each other;
wherein the first station is configured to transmit the data block to the second station via the second connection; and
wherein the second station is configured to establish a third connection to the WiFi network based upon the network information of the data block, and to disconnect the third connection when the amount of time expires.
